(19) United States
(12) Patent Application Publication
(10) Pub. No.: US 2025/0359973 A1
(43) Pub. Date: Nov. 27, 2025

(54) ANTIBACTERIAL ELECTRIC TOOTHBRUSH BASED ON PULSED ULTRASONIC PIEZOELECTRIC RESPONSE PRINCIPLE, AND ANTIBACTERIAL METHOD

(71) Applicants: PEKING UNIVERSITY SCHOOL OF STOMATOLOGY, Beijing (CN); BEIJING PIEZO-DENT MEDICAL TECHNOLOGY CO., LTD, Beijing (CN)

(72) Inventors: Xuehui ZHANG, Beijing City (CN); Xuliang DENG, Beijing City (CN); Hui Li, Beijing City (CN); Yanhui LU, Beijing City (CN); Yunyang BAI, Beijing City (CN); Shenpo YUAN, Beijing City (CN)

(21) Appl. No.: 19/124,547

(22) PCT Filed: Mar. 1, 2023
(86) PCT No.: PCT/CN2023/079028

§ 371 Date: Apr. 25, 2025

(30) Foreign Application Priority Data
Oct. 27, 2022 (CN) 202211323825.8

(51) Int. Cl. A61C 17/20; H04R 17/00; H10N 30/084; H10N 30/857

(52) U.S. Cl. CPC A61C 17/20; H04R 17/005; H10N 30/084; H10N 30/857; H04R 2217/01

(57) ABSTRACT

Disclosed in the present invention are an antibacterial electric toothbrush based on a pulsed ultrasonic piezoelectric response principle, and an antibacterial method. The electric toothbrush in the present invention comprises a toothbrush head and a driving mechanism for driving the toothbrush head to vibrate, wherein the driving mechanism is configured to generate low-intensity pulsed ultrasonic waves, and the toothbrush head is provided with piezoelectric bristles and enhances the electric responsiveness of the piezoelectric bristles by means of ultrasonic vibration, such that a good antibacterial effect is achieved. The provided electric toothbrush can not only effectively inhibit the growth of bacteria on a standing toothbrush head, but also has improved antibacterial activity during a tooth-brushing operation process, such that dental plaque can be effectively inhibited, and oral diseases, such as periodontitis, can be effectively prevented.

### TECHNICAL FIELD

The present disclosure relates to the field of electric toothbrushes, in particular to an antibacterial electric toothbrush based on pulsed ultrasonic piezoelectric response principle and an antibacterial method.

### BACKGROUND

An electric toothbrush refers to a toothbrush that utilizes a high-speed vibrating motor to drive a brush head to rotate or vibrate, thereby achieving the effect of cleaning teeth. Electric toothbrushes are generally classified into two categories: rotary electric toothbrushes and vibrating electric toothbrushes. The principle of rotary electric toothbrushes is that a motor drives a circular brush head to rotate, which enhances the friction effect while performing the standard brushing action. Rotary toothbrushes exert greater force, providing effective surface cleaning of teeth; however, they are less effective at cleaning interdental spaces and may cause greater wear on the teeth. Vibrating electric toothbrushes operate on a more complex mechanism. Typically, a vibrating electric toothbrush contains an electrically driven vibration motor that enables a brush head to vibrate at a high frequency in a direction perpendicular to a brush handle. The vibrating amplitude is relatively small, usually around 5 mm in both upward and downward directions, with the maximum industry-standard amplitude reaching 6 mm. During brushing, the high-frequency vibration of the brush head efficiently completes the cleaning action. Additionally, the high-frequency vibration causes a mixture of toothpaste and water in the oral cavity to generate a large number of microscopic bubbles.

When the bubbles burst, the resulting pressure can penetrate interdental spaces to remove dirt. However, conventional electric toothbrushes, whether rotary or vibrating types, do not possess antibacterial functionality.

Currently, some newly developed electric toothbrushes with antibacterial functionality have been disclosed. For example, CN 115068150 A discloses an electric toothbrush comprising a toothbrush body, a base, and a sleeve. The toothbrush body is mounted on the top of the base, and a locking block is fixed at the top of the base. The sleeve has a slot at its opening, corresponding to the position of the locking block, with the locking block and the slot engaged with each other. Multiple ultraviolet lamps are installed on the top of the base, arranged in a circular array along the central axis of the base. The ultraviolet lamps are positioned in an offset manner relative to the toothbrush body. Additionally, a reflective layer is installed on the inner wall of the sleeve. The patent application employs ultraviolet lamps to sterilize a brush head of the electric toothbrush but does not involve antibacterial functionality for the oral cavity.

The information provided in BACKGROUND is illustrative only of the general background of the present disclosure and should not be construed as an acknowledgment or in any way imply that this information forms the prior art, which is well known to those of ordinary skill in the art.

### SUMMARY

To address at least some of the technical problems in the prior art, the present disclosure provides an antibacterial electric toothbrush based on pulsed ultrasonic piezoelectric response principle and an antibacterial method. The present disclosure not only enables effective sterilization of a stationary toothbrush head but also enhances antibacterial activity during use. The present disclosure can effectively inhibit dental plaque and can be utilized for the prevention of periodontal diseases and other oral diseases. Specifically, the present disclosure includes the following content.

In a first aspect of the present disclosure, provided is an antibacterial electric toothbrush based on pulsed ultrasonic piezoelectric response principle comprising a toothbrush head and a driving mechanism for driving the toothbrush head to vibrate, wherein the driving mechanism is configured to be capable of generating low-intensity pulsed ultrasonic waves, and the toothbrush head is provided with piezoelectric bristles.

In certain embodiments, provided is the antibacterial electric toothbrush based on pulsed ultrasonic piezoelectric response principle according to the present disclosure, wherein the effective sound intensity of the ultrasonic waves is 0.20-2.50 W/cm².

In certain embodiments, provided is the antibacterial electric toothbrush based on pulsed ultrasonic piezoelectric response principle according to the present disclosure, wherein the frequency of the ultrasonic waves is 0.5-4 MHz.

In certain embodiments, provided is the antibacterial electric toothbrush based on pulsed ultrasonic piezoelectric response principle according to the present disclosure, wherein the piezoelectric bristles are made of at least one polymer selected from polyvinylidene fluoride, polyvinylidene fluoride-trifluoroethylene copolymer, polyvinylidene fluoride-hexafluoropropylene copolymer, polyvinylidene fluoride-tetrafluoroethylene copolymer, polymethyl methacrylate, polydimethylsiloxane, and L-polylactic acid.

In certain embodiments, provided is the antibacterial electric toothbrush based on pulsed ultrasonic piezoelectric response principle according to the present disclosure, wherein the raw material of the piezoelectric bristles further comprises a piezoelectric nanoparticle; preferably, the piezoelectric nanoparticle is selected from at least one of barium titanate, barium strontium titanate, strontium titanate, lithium niobate, and potassium sodium niobate.

In certain embodiments, provided is the antibacterial electric toothbrush based on pulsed ultrasonic piezoelectric response principle according to the present disclosure, wherein the piezoelectric bristles are prepared by a method comprising:
(1) heating a polymer to prepare a spinning melt, extruding the spinning melt through a spinneret orifice by extrusion and cooling the spinning melt to obtain a filament, and mechanically stretching the filament at a temperature of 80-100° C. and a stretching speed of 2-80 m/min so as to improve the proportion of the ferroelectric phase in the fiber filament;
(2) subjecting the filament to high-temperature treatment at a temperature of 100-150° C. for 1.5-3 h; and
(3) subjecting the filament to corona polarization treatment, wherein the corona polarization treatment conditions comprise a voltage of 10-50 kV, a distance between an electrode tip and a sample of 10-50 mm, a polarization temperature of 25-50° C., and time of 10-60 min.

In certain embodiments, provided is the antibacterial electric toothbrush based on pulsed ultrasonic piezoelectric response principle according to the present disclosure, wherein the stretching direction is essentially perpendicular to the direction of the electric field at the time of polarization.

In certain embodiments, provided is the antibacterial electric toothbrush based on pulsed ultrasonic piezoelectric response principle according to the present disclosure, wherein the bristles have a single filament diameter of 100-500 μm, the piezoelectric constant of the bristles is 0.4 pC/N or more in a stationary state, and the voltage generated by an external force is 1.0-2.0 V.

In a second aspect of the present disclosure, provided is an antibacterial method comprising a step of causing piezoelectric bristles to exhibit electric responsiveness under an ultrasonic vibration condition.

In certain embodiments, provided is the antibacterial method according to the present disclosure, further comprising a step of subjecting the piezoelectric bristles to corona polarization treatment, wherein the corona polarization treatment conditions comprise a voltage of 10-50 kV, a distance between an electrode tip and a sample of 10-50 mm, a polarization temperature of 25-50° C., and time of 10-60 min. Preferably, the antibacterial method of the present disclosure is an in vitro non-therapeutic antibacterial method.

### BRIEF DESCRIPTION OF THE DRAWINGS

FIG. 1 shows the highest output voltage of the piezoelectric bristles under different ultrasonic vibration conditions.

FIG. 2 shows the cleaning rate results of the piezoelectric bristles under different ultrasonic vibration conditions.

FIG. 3 shows the bacteriostatic rate results of the piezoelectric bristles under different ultrasonic vibration conditions.

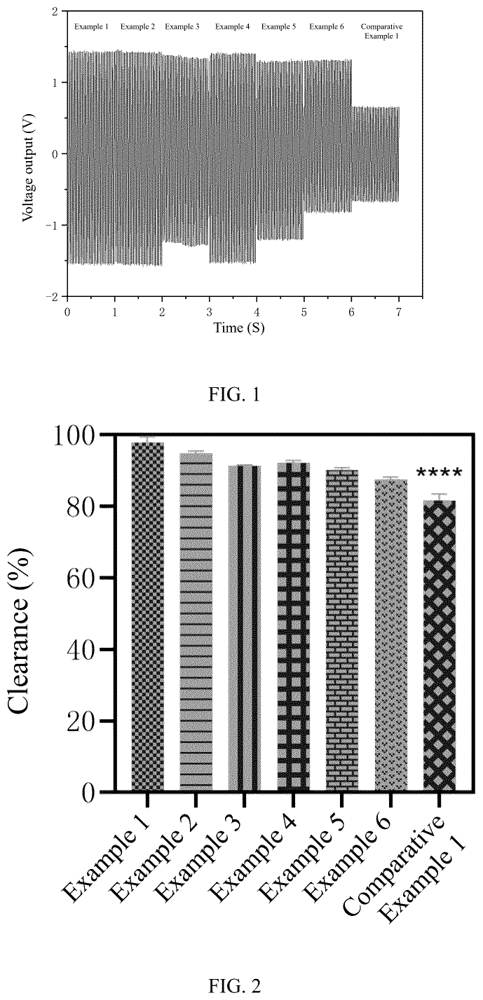

### DETAILED DESCRIPTION

Various exemplary embodiments of the present disclosure are described in detail below. The detailed description should not be construed as limitations on the present disclosure but as a more detailed description of certain aspects, features, and embodiments of the present disclosure.

It will be appreciated that the terms used herein are for the purpose of illustrating particular embodiments only, rather than limiting the present disclosure. In addition, for the numerical ranges in the present disclosure, it will be appreciated that the upper and lower limits of the ranges are specifically disclosed, as well as every intervening value between them. Every smaller range between any stated value or intervening value in a stated range and any other stated or intervening value in that stated range is encompassed within the present disclosure. The upper and lower limits of these smaller ranges may independently be included or excluded in the range.

Unless defined otherwise, all technical and scientific terms used herein have the same meaning as commonly understood by those of ordinary skill in the art to which the present disclosure pertains. Although only preferred methods and materials are described herein, any methods and materials similar or equivalent to those described herein can be used in the practice or testing of the present disclosure. All documents described herein are incorporated by reference to disclose and describe the methods and/or materials associated with the documents. In case of conflict with any incorporated document, the specification shall prevail. Unless otherwise indicated, “%” is percent by weight.

### Electric Toothbrush

In a first aspect of the present disclosure, provided is an electric toothbrush which provides an excellent antibacterial function based on pulsed ultrasonic piezoelectric response principle. In general, the electric toothbrush of the present disclosure comprises at least a toothbrush head and a driving mechanism for driving the toothbrush head to vibrate. The driving mechanism is configured to be capable of generating low-intensity pulsed ultrasonic waves, and the toothbrush head is provided with piezoelectric bristles. The present disclosure uses a combination of mechanical force (especially high-frequency mechanical vibration) and sound wave as an external force to realize the high-efficiency antibacterial purpose of the piezoelectric bristles.

In the present disclosure, the toothbrush head is not particularly limited as long as it is provided with piezoelectric bristles. The piezoelectric bristles are bristles which have piezoelectric activity while satisfying the basic requirements of toothbrush bristles, and are preferably prepared from piezoelectric polymers as raw materials. Examples of the piezoelectric polymer include, but are not limited to, polyvinylidene fluoride, polyvinylidene fluoride-trifluoroethylene copolymer, polyvinylidene fluoride-hexafluoropropylene copolymer, polyvinylidene fluoride-tetrafluoroethylene copolymer, polymethyl methacrylate, polydimethylsiloxane, and L-polylactic acid. In the present disclosure, one of the above polymers may be used, or two or more polymers may be used in combination. When two or more polymers are used in combination, the ratio of the polymers is not particularly limited, and may be any ratio.

In the present disclosure, the diameter of a bristle single filament is 100-500 μm, preferably 120-400 μm, more preferably 130-300 μm, and even more preferably 150-200 μm. The piezoelectric constant of the brush bristles in a stationary state is generally 0.4 pC/N or more, such as 0.5 pC/N or more, and 0.6 pC/N or more. The voltage generated by the external force is generally 1.0-2.0 V, such as 1.5 V or more, 1.6 V or more, etc.

In certain embodiments, the raw material of the piezoelectric bristles of the present disclosure further comprises an inorganic piezoelectric material, which are typically nanoscale ceramic particles, examples of which include, but are not limited to, barium titanate, barium strontium titanate, strontium titanate, lithium niobate, and potassium sodium niobate. Combinations of one or more of the above components may be used in the present disclosure. In the case of combination, the amount ratio of each component is not limited, and can be freely set as required. The particle size of the inorganic piezoelectric material is generally 1-500 nm, preferably 10-300 nm, more preferably 20-200 nm, and further preferably 30-100 nm. In the present disclosure, the inorganic piezoelectric material is used in the piezoelectric bristle raw material in an amount of generally 0-20%, preferably 1-15%, and more preferably 5-10% by weight. In certain embodiments, the piezoelectric bristles of the present disclosure further comprise a physical treatment step. Exemplary physical treatments include annealing and/or polarization treatments, thereby further substantially increasing the antimicrobial activity of the bristles. The annealing treatment generally includes allowing the piezoelectric bristles to stand at a high temperature for 30 min to 3 hours, preferably 50 min to 2.5 h, and further preferably 1 h to 2 h. High temperatures generally refer to 100-150° C., preferably 110-140° C., and further preferably 120-130° C. The condition of the polarization treatment generally includes that the polarization medium is one of air and methyl silicone oil, and the polarization voltage is 1-30 kV, and more preferably 2-25 kV. The distance between the electrode tip and the sample is set to be 1-50 mm, for example, 5 mm, 10 mm, 15 mm, 20 mm, 25 mm, 30 mm, 35 mm, etc. The polarization temperature is 20-50° C., for example, 25° C., 30° C., 35° C., or 40° C. The polarization time is 1-60 min, for example, 5 min, 10 min, 15 min, 20 min, 30 min, 40 min, and the like.

In certain embodiments, the piezoelectric bristles of the present disclosure are prepared by a melt spinning process. Illustratively, the preparation method comprises the following steps:
(1) heating a polymer to prepare a spinning melt, extruding the spinning melt through a spinneret orifice by extrusion and cooling the spinning melt to obtain a filament, and mechanically stretching the filament at a temperature of 80-100° C. and a stretching speed of 2-80 m/min so as to improve the proportion of the ferroelectric phase in the fiber filament;
(2) subjecting the filament to high-temperature treatment at a temperature of 120-150° C. for 1.5-3 h; and
(3) subjecting the filament to corona polarization treatment, wherein the corona polarization treatment conditions comprise a voltage of 10-50 kV, a distance between an electrode tip and a sample of 10-50 mm, a polarization temperature of 25-50° C., and time of 10-60 min.

In the present disclosure, the antibacterial activity of the bristles is improved by stretching at a speed of generally 2-80 m/min, preferably 5-50 m/min, and further preferably 10-30 m/min, for example, 15 m/min, 20 m/min, and 25 m/min. Preferably, the stretching direction is essentially perpendicular to the direction of the electric field at the time of polarization.

In the present disclosure, the driving mechanism is not particularly limited as long as it can simultaneously supply a mechanical force for vibrating the bristles and preferably further supply ultrasonic waves, which may be any power supply apparatus or unit. Preferably, the vibration period of the driving mechanism is synchronized with the vibration period of the brush head or bristles. Further preferably, the vibration period of the driving mechanism is on the same order of magnitude as the frequency of the sound wave of the ultrasonic wave, which is referred to as ultrasonic vibration.

In the present disclosure, when the driving mechanism further supplies the ultrasonic wave, it is preferable that the effective sound intensity of the ultrasonic wave generated by the driving mechanism is 0.20-2.50 W/cm², preferably 0.25 W/cm² or more, and more preferably 2.4 W/cm² or less. The inventors have surprisingly found that the voltage generated from the piezoelectric bristles is not increased but decreased as the effective sound intensity is increased, and that the output voltage and the antibacterial activity are high when the effective sound intensity is controlled within the above range. In addition, the frequency of the ultrasonic wave is generally 0.5-4 MHz, such as 1 MHz, 2 MHz, 3 MHz, etc. The inventors have found that as the frequency becomes higher, the output voltage decreases instead. This effect is surprising. When the frequency of the ultrasonic wave is within the above range, the output voltage is relatively high.

In certain embodiments, the driving mechanism of the present disclosure produces both mechanical vibration and ultrasonic wave. The mechanical vibration and the ultrasonic wave may be generated by the same component or apparatus, or may be generated by different components or apparatuses of the driving mechanism. For example, mechanical vibrations can be generated by a motor, while ultrasonic waves can be generated and emitted by, for example, a piezoelectric transducer, which is excited by an MCU-driven circuit. In certain embodiments, the driving mechanism of the present disclosure is configured to be capable of providing vibration or ultrasonic wave in a pulsed manner. By pulsed it is meant that the vibration or ultrasound is output at fixed and/or variable time intervals, e.g. 1-20 ms, preferably 1-10 ms, e.g. 2 ms, 3 ms, 4 ms, 5 ms, 6 ms, etc., or provided in such a manner that different vibrations or ultrasound are output for fixed and/or variable time. The different vibrations mean, for example, vibrations having different vibration frequencies or vibration intensities. Different ultrasound refers to, for example, ultrasound of different frequencies or ultrasound of different intensities. In an exemplary embodiment, the pulsed manner simultaneously outputs the vibrations and ultrasound at fixed 1 ms intervals. In further exemplary embodiments, the pulsed manner simultaneously outputs the vibrations and ultrasound at variable time intervals, for example a first pulsed wave followed by an interval of, for example, 1 ms, and then a second pulsed wave followed by an interval of, for example, 2 ms. The variable time interval may be regular, e.g., gradually larger or smaller, or irregular. In addition to the driving mechanism and toothbrush head, the electric toothbrush of the present disclosure may include other components or mechanisms known in the art. For example, a toothbrush handle, a microcontroller, a detector, a power or a charging interface, etc.

In certain embodiments, the electric toothbrush of the present disclosure further comprises a microcontroller and a detector, and the microcontroller, the detector, and the driving mechanism are in communicative connection. The detector is configured to detect a condition of teeth in the oral cavity, such as caries, and to transmit the detection result to the microcontroller, which then sends different execution commands to the driving mechanism depending on the detection result.

Preferably, the execution commands include an instruction for the driving mechanism to output the desired working frequency or vibration frequency.

### Antibacterial Method

In a second aspect of the present disclosure, provided is an antibacterial method comprising a step of causing piezoelectric bristles to exhibit enhanced electric responsiveness under an ultrasonic vibration condition.

According to the present disclosure, antibacterial action is achieved through ultrasound. Ultrasonic antibacterial action not only disrupts the structure of bacteria via the acoustic energy of ultrasound but, more importantly, converts ultrasound into the mechanical vibration of piezoelectric bristles. This mechanical vibration subsequently generates piezoelectric activity, thereby achieving an antibacterial effect. The present disclosure has found that the stronger the piezoelectric activity, the higher the antibacterial effect. Preferably, the present disclosure synergistically realizes an excellent antibacterial effect by the combination of the above-mentioned two effects of ultrasound.

In certain embodiments, the antibacterial method of the present disclosure has a stronger effect, and therefore, can be understood as a method for improving antibacterial effect, which comprises not only providing ultrasound to the piezoelectric bristles but also further comprising providing a mechanical force to the piezoelectric bristles, preferably a mechanical vibration. Further preferably, the frequency of the mechanical vibration is the same as or comparable to the frequency of the ultrasound. Herein, “comparable” means that the vibration frequency is within. ±30% of the ultrasonic frequency, for example, the ultrasonic frequency is 1 MHz, and the mechanical vibration frequency is in the range of 0.7-1.3 MHz. Preferably, “comparable” means that the vibration frequency is within ±20%, such as within ±10%.

In certain embodiments, the antibacterial method of the present disclosure is a method for improving antibacterial effect, which further comprises the step of physically treating the piezoelectric bristles. Physical treatment includes annealing treatment and corona polarization treatment. The conditions of the annealing treatment and the corona polarization treatment are described in the above section of “electric toothbrush”, and will not be described herein again.

In certain embodiments, the antibacterial action of the present disclosure is applied to in vitro environmental sterilization, such as sterilization while cleaning an object surface using a brush.

### EXAMPLE

### I. Preparation of Bristles

### 1. Bristle 1

(1) 1 kg of PVDF was weighed out and added to a single-screw melt spinning machine, heated to the melting temperature of 175° C. of PVDF at a heating rate of 10° C./min. The granules were completely melted, extruded through a spinning nozzle and wound to obtain a filament with the diameter of 160 μm. The piezoelectric constant of the PVDF was 19 pC/N.
(2) The filament was mechanically stretched at the temperature of 85° C. at the stretching speed of 5 m/min, and then subjected to high-temperature treatment at 120°° C. for 2 h.
(3) The toothbrush filament was obtained through corona polarization treatment, wherein the voltage of the corona polarization treatment was 35 kV, the distance was 35 mm, the temperature was 25° C., and the time was 30 min. The tensile strength of bristle 1 was 493.1 Mpa, the elastic modulus was 853.5 MPa, the bundle tension was 31.3 N, the bundle bending force was 2.90 N, and the single filament bending recovery rate was 66.43%.

### 2. Bristle 2

(1) 1 kg of PVDF was weighed out and added to a single-screw melt spinning machine, heated to the melting temperature of 175° C. of PVDF at a heating rate of 10° C./min. The granules were completely melted, and BaTiO₃ was added at a ceramic particle BaTiO₃:polymer ratio of 1:10. The mixture was extruded through a spinning nozzle and wound to obtain a filament with the diameter of 160 μm. The piezoelectric constant of the PVDF was 19 pC/N.
(2) The filament was mechanically stretched at the temperature of 85° C. at the stretching speed of 5 m/min, and then subjected to high-temperature treatment at 120° C. for 2 h.
(3) The toothbrush filament was obtained through corona polarization treatment, wherein the voltage of the corona polarization treatment was 35 kV, the distance was 35 mm, the temperature was 25° C., and the time was 30 min.

The tensile strength of bristle 2 was 483.5 Mpa, the elastic modulus was 832.2 MPa, the bundle tension was 28.3 N, the bundle bending force was 2.81 N, and the single filament bending recovery rate was 62.76%.

The tension of the bristles 1 and 2 was more than or equal to 15 N, and the bending force was both less than 6 N. The bristles had good single filament bending recovery rate, tensile strength, and elastic modulus, which met the requirements in the national standard GB 19342-2013.

### II. Electric Tooth Brushing Simulation

The bristles were fixed on the probe of an ultrasonic therapeutic apparatus through a coupling agent. The probe applied the power of the vibration of the bristles, and meanwhile, the probe also generated ultrasonic waves which simultaneously acted on the bristles. Thus, the process of electric tooth brushing was simulated. Specific working conditions are shown in Table 1.

### III. Effect of Experiment

### 1. Voltage Output

The bristles were cut to a length of 10 cm. A clamp was used to hold the bristles in a tensioned state. Conductive adhesive and electrodes were bonded at both ends. The electrodes at both ends were connected to a Keithley 6514 electrometer. An ultrasonic pulse with a working frequency of 0 MHz, 1 MHz±10%, or 3 MHz±10% and ultrasonic vibration with an ultrasonic effective sound intensity of 0.25-2.25 W/cm² were applied. This caused the bristles to vibrate in a regular sweeping motion, and the voltage output was received on the screen.

TABLE 1
Maximum output voltage produced by bristles under different ultrasonic conditions

| | | Effective sound intensity (W/cm²) and pulse interval (ms) | | |
|---|---|---|---|---|
| Working frequency (MHz) | | 0.25, 1 | 1.25, 5 | 2.25, 9 |
| Bristle 1 | 1 | Example 1 (1.45 V) | Example 2 (1.44 V) | Example 3 (1.39 V) |
| | 3 | Example 4 (1.43 V) | Example 5 (1.33 V) | Example 6 (1.32 V) |
| Bristle 2 | 1 | Example 7 (1.76 V) | Example 8 (1.72 V) | Example 9 (1.71 V) |
| | 3 | Example 10 (1.68 V) | Example 11 (1.65 V) | Example 12 (1.61 V) |

It can be seen from the data in Table 1 that as the effective sound intensity increased, the output voltage decreased in inverse proportion, while as the ultrasonic working frequency increased, the output voltage decreased in inverse proportion.

### 2. Pulsed Ultrasonic Tooth Brushing Cleaning Rate

Bovine teeth were selected as stain carriers. After preliminary sandblasting and cleaning, they were sequentially immersed in an albumin solution, a mixture of tea and coffee, and a ferric citrate solution for 30 min. This process was repeated until the stains were firmly attached to the surface of the bovine teeth for later use.

The stained samples were placed in the sample slot of a brushing machine, ensuring that the stain surface was level with the surface of the sample slot. The brush head and force arm were adjusted to conform to the stain surface. Regular toothpaste was poured into the sample slot, and a simulated pulsed ultrasonic brushing test was conducted by applying different ultrasonic working frequencies and ultrasonic effective sound intensities to the brush head, along with the specified load. The stain cleaning capability was measured by the area of stain removal.

### 3. Pulsed Ultrasonic Bacteriostatic Rate

Bovine teeth and oral dental plaque bacteria were co-cultured in BHI liquid medium for 12 h. The medium was pipetted out using a pipette, and the teeth were gently washed once with sterile normal saline to remove the suspended bacteria. The stained samples were placed in the sample slot of a brushing machine, ensuring that the stain surface was level with the surface of the sample slot. The brush head and force arm were adjusted to conform to the stain surface. Regular toothpaste was poured into the sample slot, and a simulated pulsed ultrasonic brushing test was conducted by applying different ultrasonic working frequencies and ultrasonic effective sound intensities to the brush head, along with the specified load. After the tooth brushing experiment, an appropriate amount of dye solution was dropped onto the surface of the bovine teeth and incubated in the dark at room temperature for 15 min. The teeth were carefully rinsed with PBS buffer to remove excess dye. A laser confocal microscope (CLSM) was used to observe and capture images, obtaining red and green fluorescence intensities. The bacteriostatic rate was calculated by comparing these intensities with the untreated group.

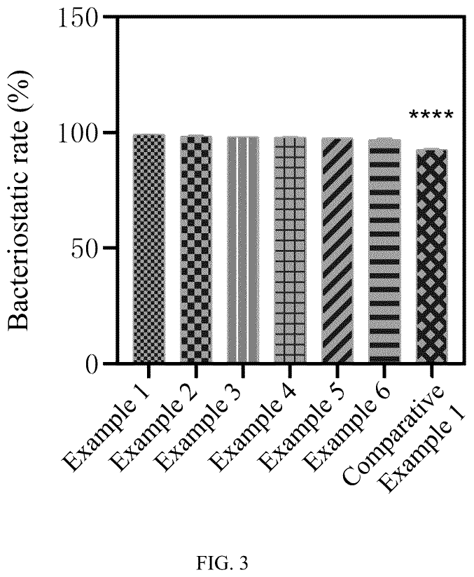

From FIGS. 2 and 3, it can be observed that the antibacterial effect and clearance were directly proportional to the output voltage.

### Comparative Example 1

(1) 1 kg of PVDF was weighed out and added to a single-screw melt spinning machine, heated to the melting temperature of 175° C. of PVDF at a heating rate of 10° C./min. The granules were completely melted, extruded through a spinning nozzle and wound to obtain a filament with the diameter of 160 μm. The piezoelectric constant of the PVDF was 19 pC/N.
(2) The filament was subjected to annealing treatment at 120° C. for 2 h.
(3) The toothbrush filament was obtained through corona polarization treatment, wherein the voltage of the corona polarization treatment was 35 kV, the distance was 35 mm, the temperature was 25° C., and the time was 30 min.
(4) Pulsed ultrasound was not applied.

The highest output voltage was measured to be 0.665 V.

### Comparative Example 2

(1) 1 kg of PVDF was weighed out and added to a single-screw melt spinning machine, heated to the melting temperature of 175° C. of PVDF at a heating rate of 10° C./min. The granules were completely melted, extruded through a spinning nozzle and wound to obtain a filament with the diameter of 160 μm. The piezoelectric constant of the PVDF was 19 pC/N.
(2) The filament was subjected to annealing treatment at 120° C. for 2 h.
(3) The toothbrush filament was obtained through corona polarization treatment, wherein the voltage of the corona polarization treatment was 35 kV, the distance was 35 mm, the temperature was 25° C., and the time was 30 min.
(4) The bristles were fixed on the probe of an ultrasonic therapeutic apparatus through a coupling agent. The probe applied the power of the vibration of the bristles, and meanwhile, the probe also generated ultrasonic waves which simultaneously acted on the bristles. The ultrasonic working frequency was 1 MHz±10%, the ultrasonic effective sound intensity was 0.25 W/cm², and the pulse time interval was 1 ms. The maximum output voltage of the bristles was measured to be 1.31 V.

### Comparative Example 3

(1) 1 kg of PVDF was weighed out and added to a single-screw melt spinning machine, heated to the melting temperature of 175° C. of PVDF at a heating rate of 10° C./min. The granules were completely melted, extruded through a spinning nozzle and wound to obtain a filament with the diameter of 160 μm. The piezoelectric constant of the PVDF was 19 pC/N.
(2) The toothbrush filament was obtained through corona polarization treatment, wherein the voltage of the corona polarization treatment was 35 kV, the distance was 35 mm, the temperature was 25° C., and the time was 30 min.
(3) The bristles were fixed on the probe of an ultrasonic therapeutic apparatus through a coupling agent. The probe applied the power of the vibration of the bristles, and meanwhile, the probe also generated ultrasonic waves which simultaneously acted on the bristles. The ultrasonic working frequency was 1 MHz±10%, the ultrasonic effective sound intensity was 0.25 W/cm², and the pulse time interval was 1 ms. The maximum output voltage of the bristles was measured to be 0.95 V.

### Comparative Example 4

(1) 1 kg of PVDF was weighed out and added to a single-screw melt spinning machine, heated to the melting temperature of 175° C. of PVDF at a heating rate of 10° C./min. The granules were completely melted, extruded through a spinning nozzle and wound to obtain a filament with the diameter of 160 μm. The piezoelectric constant of the PVDF was 19 pC/N.
(2) The filament was mechanically stretched at the temperature of 85° C. at the stretching speed of 5 m/min, and then subjected to high-temperature treatment at 120° C. for 2 h.
(3) The toothbrush filament was obtained through corona polarization treatment, wherein the voltage of the corona polarization treatment was 35 kV, the distance was 35 mm, the temperature was 25° C., and the time was 30 min.
(4) Ultrasonic waves were generated through an ultrasonic therapeutic apparatus. The ultrasonic waves were directly applied to the bristles, and mechanical vibration was not applied to the bristles. The ultrasonic working frequency is 1 MHz±10%, the ultrasonic effective sound intensity is 0.25W/cm², and the pulse time interval is 1 ms. The highest output voltage was measured to be 0.78 V.

### Comparative Example 5

(1) 1 kg of PVDF was weighed out and added to a single-screw melt spinning machine, heated to the melting temperature of 175° C. of PVDF at a heating rate of 10° C./min. The granules were completely melted, extruded through a spinning nozzle and wound to obtain a filament with the diameter of 160 μm. The piezoelectric constant of the PVDF was 19 pC/N.
(2) The filament was mechanically stretched at the temperature of 85° C. at the stretching speed of 5 m/min, and then subjected to high-temperature treatment at 120° C. for 2 h.
(3) The toothbrush filament was obtained through corona polarization treatment, wherein the voltage of the corona polarization treatment was 35 kV, the distance was 35 mm, the temperature was 25° C., and the time was 30 min.
(4) The bristles were fixed on the probe of an ultrasonic therapeutic apparatus through a coupling agent. The probe applied the power of the vibration of the bristles, and meanwhile, the probe also generated ultrasonic waves which simultaneously acted on the bristles, but continuously act without pulses. Specifically, the bristles were cut to a length of 10 cm. A clamp was used to hold the bristles in a tensioned state. Conductive adhesive and electrodes were bonded at both ends. The electrodes at both ends were connected to a Keithley 6514 electrometer. Continuous vibration with a frequency of 1 MHz±10% was applied, and the ultrasonic effective sound intensity was 2.5 W/cm². This caused the bristles to vibrate in a regular sweeping motion, and the voltage output was received on the screen. The highest output voltage was measured to be 1.25 V.

Bovine teeth were selected as stain carriers. After preliminary sandblasting and cleaning, they were sequentially immersed in an albumin solution, a mixture of tea and coffee, and a ferric citrate solution for 30 min. This process was repeated until the stains were firmly attached to the surface of the bovine teeth for later use.

The stained samples were placed in the sample slot of a brushing machine, ensuring that the stain surface was level with the surface of the sample slot. The brush head and force arm were adjusted to conform to the stain surface. Regular toothpaste was poured into the sample slot, and a simulated brushing test was conducted by applying continuous vibration with the frequency of 1 MHZ±10% and the ultrasonic effective sound intensity of 2.5 W/cm² to the brush head, along with the specified load. The stain cleaning capability was measured by the area of stain removal. The clearances (3 replicates) were: 86.3%, 87.1%, and 86.7%. The average was 86.7%.

Bovine teeth and oral dental plaque bacteria were co-cultured in BHI liquid medium for 12 h. The medium was pipetted out using a pipette, and the teeth were gently washed once with sterile normal saline to remove the suspended bacteria. The stained samples were placed in the sample slot of a brushing machine, ensuring that the stain surface was level with the surface of the sample slot. The brush head and force arm were adjusted to conform to the stain surface. Regular toothpaste was poured into the sample slot, and a simulated brushing test was conducted by applying continuous vibration with the frequency of 1 MHz±10% and the ultrasonic effective sound intensity of 2.5 W/cm² and the specified load. After the tooth brushing experiment, an appropriate amount of dye solution was dropped onto the surface of the bovine teeth and incubated in the dark at room temperature for 15 min. The teeth were carefully rinsed with PBS buffer to remove excess dye. A laser confocal microscope (CLSM) was used to observe and capture images, obtaining red and green fluorescence intensities. The bacteriostatic rate was calculated by comparing these intensities with the untreated group. The bacteriostatic rates (3 replicates) were: 96.1%, 95.5%, and 95.8%. The average was 95.8%.

TABLE 2
Dental floss clearance data under different ultrasound conditions (3 replicates)

| | | | | | | Comparative |
|---|---|---|---|---|---|---|
| Example 1 | Example 2 | Example 3 | Example 4 | Example 5 | Example 6 | Example 1 |
| 99.3 | 98.9 | 98.26 | 98 | 97.65 | 96.5 | 93.2 |
| 99.19 | 98.1 | 98.3 | 97.9 | 97.53 | 97.1 | 92.7 |
| 99.17 | 98.5 | 98.28 | 98.34 | 97.72 | 97.61 | 92.6 |

TABLE 3
Dental floss bacteriostatic rate data under different
ultrasound conditions (3 replicates)

| | | | | | | Comparative |
|---|---|---|---|---|---|---|
| Example 1 | Example 2 | Example 3 | Example 4 | Example 5 | Example 6 | Example 1 |
| 99 | 94.67 | 91.33 | 91.67 | 89.67 | 87 | 83.67 |
| 98.67 | 94.33 | 91.67 | 92 | 90 | 87.33 | 81 |
| 96.3 | 95.67 | 91.33 | 93 | 91 | 88.33 | 80.67 |

Although the present disclosure has been described with reference to exemplary embodiments, it is to be understood that the present disclosure is not limited to the disclosed exemplary embodiments. Various modifications and variations can be made to the exemplary embodiments in the specification of the present disclosure without departing from the scope or spirit of the present disclosure. The scope of the claims should be based on the broadest interpretation to encompass all modifications and equivalent structures and functions.

1. An antibacterial electric toothbrush based on pulsed ultrasonic piezoelectric response principle, comprising a toothbrush head and a driving mechanism for driving the toothbrush head to vibrate, wherein the driving mechanism is configured to be capable of generating low-intensity pulsed ultrasonic waves, and the toothbrush head is provided with piezoelectric bristles.

2. The antibacterial electric toothbrush based on pulsed ultrasonic piezoelectric response principle according to claim 1, wherein the effective sound intensity of the ultrasonic waves is 0.20-2.50 W/cm².

3. The antibacterial electric toothbrush based on pulsed ultrasonic piezoelectric response principle according to claim 1, wherein the frequency of the ultrasonic waves is 0.5-4 MHz; and/or the ultrasonic waves are generated in fixed and/or variable pulse modes or in a way that different vibrations or ultrasound are output in fixed and/or variable time periods.

4. The antibacterial electric toothbrush based on pulsed ultrasonic piezoelectric response principle according to claim 1, wherein the piezoelectric bristles are made of at least one polymer selected from polyvinylidene fluoride, polyvinylidene fluoride-trifluoroethylene copolymer, polyvinylidene fluoride-hexafluoropropylene copolymer, polyvinylidene fluoride-tetrafluoroethylene copolymer, polymethyl methacrylate, polydimethylsiloxane, and polylactic acid.

5. The antibacterial electric toothbrush based on pulsed ultrasonic piezoelectric response principle according to claim 4, wherein the raw material of the piezoelectric bristles further comprises a piezoelectric nanoparticle, wherein the piezoelectric nanoparticle is selected from at least one of barium titanate, barium strontium titanate, strontium titanate, lithium niobate, and potassium sodium niobate.

6. The antibacterial electric toothbrush based on pulsed ultrasonic piezoelectric response principle according to claim 1, wherein the piezoelectric bristle is prepared by a method comprising:
(1) heating a polymer to prepare a spinning melt, extruding the spinning melt through a spinneret orifice by extrusion and cooling the spinning melt to obtain a filament, and mechanically stretching the filament at a temperature of 80-100° C. and a stretching speed of 2-80 m/min;
(2) subjecting the filament to high-temperature treatment at a temperature of 100-150° C. for 1.5-3 h; and
(3) subjecting the filament to corona polarization treatment, wherein the corona polarization treatment conditions comprise a voltage of 10-50 kV, a distance between an electrode tip and a sample of 10-50 mm, a polarization temperature of 25-50° C., and time of 10-60 min.

7. The antibacterial electric toothbrush based on pulsed ultrasonic piezoelectric response principle according to claim 6, wherein the stretching direction is essentially perpendicular to the direction of the electric field at the time of polarization.

8. The antibacterial electric toothbrush based on pulsed ultrasonic piezoelectric response principle according to claim 1, wherein the bristles have a single filament diameter of 100-500 μm, the piezoelectric constant of the bristles is 0.4 pC/N or more in a stationary state, and the voltage generated by an external force is 1.0-2.0 V.

9. An antibacterial method, comprising a step of causing piezoelectric bristles to generate piezoelectric response under an ultrasonic vibration condition so as to realize an antibacterial function.

10. The antibacterial method according to claim 9, further comprising a step of causing piezoelectric bristles to generate piezoelectric response, or further comprising a step of subjecting piezoelectric bristles to high-temperature treatment or corona polarization treatment.
